(19) United States
(12) Patent Application Publication
(10) Pub. No.: US 2007/0081249 A1
(43) Pub. Date: Apr. 12, 2007

(54) Optical system for reducing the reflection of optically transparent substrates

(75) Inventors: Ulrike Schulz, Kunitz (DE); Norbert Kaiser, Jena (DE); Uwe Schallenberg, Jena (DE)

Correspondence Address: BARNES & THORNBURG LLP, 11 SOUTH MERIDIAN, INDIANAPOLIS, IN, 46204, US

(73) Assignee: Fraunhofer-Gesellschaft Zur Forderung Der Angewand, Munich (DE)

(21) Appl. No.: 10/573,720

(22) PCT Filed: Sep. 13, 2004
(86) PCT No.: PCT/DE04/02091

§ 371 Date: Dec. 11, 2006

(30) Foreign Application Priority Data
Sep. 29, 2003 (DE) 103 46 282.1
Nov. 11, 2003 (DE) 103 54 091.1

(51) Int. Cl. G02B 1/10

(52) U.S. Cl. 359/588

(57) ABSTRACT

The invention relates to an optical system for reducing the reflection of optically transparent substrates. A layer system consisting of alternately arranged layers is formed on the surface of the respective substrate. The aim of the intention is to reduce the proportion of reflected light within a broad wavelength range, whereby it is possible to have a specific influence upon the value of the reflection, the respective wavelength range wherein a reduction is obtained, and, optionally, upon a colour impression arising therefrom. According to the invention, the alternately arranged layers of materials having lower and higher optical refraction indexes form stacks of layers. Said stacks of layers have an equivalent optical refraction index, in relation to a predefinable wavelength lambda, which is lower than the optical refraction index of the substrate. At least two stacks of layers are formed on top of each other, wherein, the respective equivalent refraction index is increasingly reduced starting from the substrate. The optical thickness of the individual stacks of layers is such that it corresponds to twice the value of ¼ of the predefinable wavelength lambda.

The invention relates to an optical system for reducing the reflection of optically transparent substrates. The layer system is thereby formed by means of layers which are disposed alternately on the surface of a respective substrate and are formed respectively from one material with a lower optical refractive index and from a second material with a higher optical refractive index. It can be used preferably in the wavelength range of visible light.

With the solution according to the invention, a significant reduction in the reflection of incident light on the surface of the respective substrate within a relatively extensively encompassed wavelength range (spectral range) can be achieved. In addition, the influence of different angles of incidence of the light is reduced relative to conventional solutions and a most extensive colour neutrality can be achieved. Hence, optically transparent substrates coated according to the invention can be used for the most varied of applications. Hence, such layer systems can be used for example for spectacle lenses made of glass and plastic materials, coverings for electronic display elements (displays) and also protective coverings or housings for plastic material objects.

Thus it is known in principle to form alternate layer systems comprising individual layers which are in turn formed from materials with different optical refractive indices in order to reduce reflections of incident light on surfaces on optically transparent substrates.

Normally, the so-called 3-layer systems MHL are thereby used. In the case of such layer systems there is a first outer layer L which abuts directly on the surrounding atmosphere, generally air, a layer which has a lower optical refractive index than the optical refractive index of the respective substrate. The middle layer is made of a material which has a higher optical refractive index and the M-layer has an optical refractive index which is between the optical refractive index of the substrate and the higher optical refractive index.

Layer thicknesses are chosen thereby for these individual layers which correspond to the optical thickness (product of physical thickness and optical refractive index), ¼ of a prescribed wavelength λ for the respectively two outer layers of such a 3-layer system. The intermediate layer made of the material with the higher optical refractive index is formed in contrast thereto with an optical thickness of ½ of this wavelength λ. This prescribed wavelength was thereby selected from a wavelength interval in which the reduction in reflection of the light is intended to be effected and is normally in the range between 480 and 600 nm.

It is proposed in U.S. Pat. No. 3,432,225, instead of such a 3-layered construction, to choose a 3-layered extension in which the layer region with the middle optical refractive index is replaced by attributable parts of layers which are formed from the materials with the lower optical refractive index and the higher optical refractive index.

Here, the 3-layer thicknesses, which correspond to¼ of a wavelength λ, are used again.

With these so-called classic antireflection coatings which are frequently used also in combination with hard layers on plastic material substrates, the proportion of the visible light reflected on the surfaces in the wavelength range between 420 nm and 680 nm can be reduced on average to ≦1%. For this purpose, a colour effect in the direction blue or green is however shown which leads to changes even in the case of slight deviations in the formation of such layer systems so that it becomes necessary for example when repairing spectacles to exchange both lenses of the spectacles although only one would require to be exchanged.

In the known solutions, such colour changes are also disadvantageous when different light incidence angles or viewing angles can occur. In the case of light incidence at an obliquely inclined angle, the reflective proportion of light is again increased significantly.

In the known solutions, it is problematic in addition to achieve the desired significant reduction in the reflected proportion of the respective lightwave spectrum without producing a colour effect in substrates, the optical refractive index of which is relatively low. This applies in particular to substrate materials, such as glass and suitable plastic materials, such as for example polymethylmethacrylate or polycarbonate, the optical refractive indices of which are in the range between 1.5 and 1.6 with an average wavelength of the visible light since there are only a few selected materials or chemical compounds, the optical refractive index of which is lower than that of such a substrate.

It is therefore the object of the invention to reduce the reflected proportion of incident light in a broad wavelength range of visible light which is reflected on the surface, a specific influence being possible on the value of the reflection itself, on the respective wavelength range in which a reduction is achievable and/or a specific influence on a resulting colour effect.

This object is achieved according to the invention with the help of an optical system which is defined by claim 1. Advantageous embodiments and developments of the invention can be achieved with the features described in the subordinate claims.

The optical layer system according to the invention is formed from alternately disposed layers of a material with a lower optical refractive index and layers of a higher optical refractive index.

Layer stacks comprising such layers are thereby formed. These layer stacks then have an equivalent optical refractive index relative to a prescribable wavelength λ. This equivalent optical refractive index is lower than the optical refractive index of the substrate. Each layer stack should thereby be observed optically such that it forms an individual layer.

The prescribable wavelength λ can be in the wavelength range in which the reduced reflectivity is intended to be achieved.

Such an individual layer stack is formed from at least one layer H of a material with a higher optical refractive index. This layer H is enclosed on both sides by two layers which are formed from a material with the lower optical refractive index.

Accordingly, also a plurality of layers H in a layer stack of a material with a higher optical refractive index can be enclosed by layers L on both sides.

An optical layer system according to the invention is thereby formed from at least two layer stacks which are formed one above the other. The layer stacks thereby have an equivalent optical refractive index which is different one from the other and the equivalent optical refractive index of the layer stacks is reduced starting from the substrate towards the surrounding medium (in general air).

The individual layer stacks of an optical layer system should have an optical thickness which corresponds at least to twice ¼ of the prescribable wavelength λ. Preferably, they should have optical thicknesses which correspond to an integer multiple of ¼ of the prescribable wavelength λ.

It is advantageous in addition that all the equivalent optical refractive indices of all the layer stacks are lower than the optical refractive index of the material from which the layers L with a lower optical refractive index are formed.

Accordingly, the equivalent optical refractive index of the layer stacks is reduced progressively, starting from the surface of the substrate towards the surrounding medium.

In the case of the layer system according to the invention, all the individual layers H and L of the entire layer system can have an optical layer thickness which deviates from an integer multiple of ¼ of the prescribable wavelength λ.

In the case where, for an individual layer which is formed directly on the surface of the substrate, a material was used, the optical refractive index of which is lower than the optical refractive index of the substrate, a part of this layer can be formed as λ/4 layer for the prescribed wavelength λ under consideration.

The optical layer system according to the invention can be formed advantageously on substrates, the optical refractive index of which is ≦2, i.e. also in the range between 1.5 and 1.6.

The layers L, the optical refractive index of which is lower can advantageously be formed from SiO₂ or MgF₂ since these optical refractive indices in each case are lower than the optical refractive indices of the substrate materials which are normally used.

The layers H, the optical refractive index of which is higher, can be formed from TiO₂, HfO₂, ZrO₂, Ta₂O₅ and/or Nb₂O₂, the optical refractive indices n of which are in the range of 1.9 to 2.35.

The number of individual layers which respectively form a single layer stack can have been chosen to be three to seven layers, the wavelength range in which the reflection is reduced being able to be influenced by the number of layers for the respective layer stacks and correspondingly also the thickness of the layer stacks.

The number of layers of all the layer stacks of the layer system can be respectively identical. This applies analogously also to the optical layer thickness of the layer stacks of an optical layer system which likewise can be identical.

It is advantageous in addition to form the uppermost layer of the layer system which is in contact directly with the surrounding medium from a material with a lower optical refractive index. The latter should thereby have an optical layer thickness which is greater than ¼ of the prescribed wavelength λ.

In the case of the optical layer system according to the invention, the proportions of the entire layer thicknesses of layers H, which are formed from a material with a higher optical refractive index, are increased successively starting from the substrate surface in the direction of the surrounding medium so that the summated optical layer thicknesses H in this direction are increased relative to the summated optical layer thicknesses of layers L of parts of such layers.

The respective prescribed wavelength λ should preferably be selected from the wavelength range between 480 and 600 nm, preferably between 500 and 550 nm.

The entire layer system can have a physical thickness in the range between 800 to 3,000 nm so that, in particular with substrates made of plastic materials, there is improved mechanical protection and a sufficiently high adhesive strength and scratch resistance.

In the described plastic material substrates, there is an advantageous effect in addition in that a proportion of layers H, which must be formed from a material with a higher optical refractive index, is relatively low for an entire optical layer system so that, when forming the layer in a vacuum, only slight heating of the substrate can be noted.

The respective number of layer stacks and if necessary a λ/4 layer comprising a material with a lower optical refractive index than the substrate material, prescribe the number of steps with which the optical refractive index of an optical layer system, starting from the substrate surface towards the surrounding medium, can be reduced.

By a specific selection of the thickness of the respective layer stacks, as integer multiple of a λ/4 layer thickness (QW), the wavelength range in which the desired reflection-reducing effect can be achieved, can be influenced. Thus a higher wavelength range can be covered if layer stacks, the optical layer thickness of-which is higher than 3 times ¼ of the prescribed wavelength are used.

The invention is intended to be explained subsequently in more detail by way of example.

There are thereby shown:

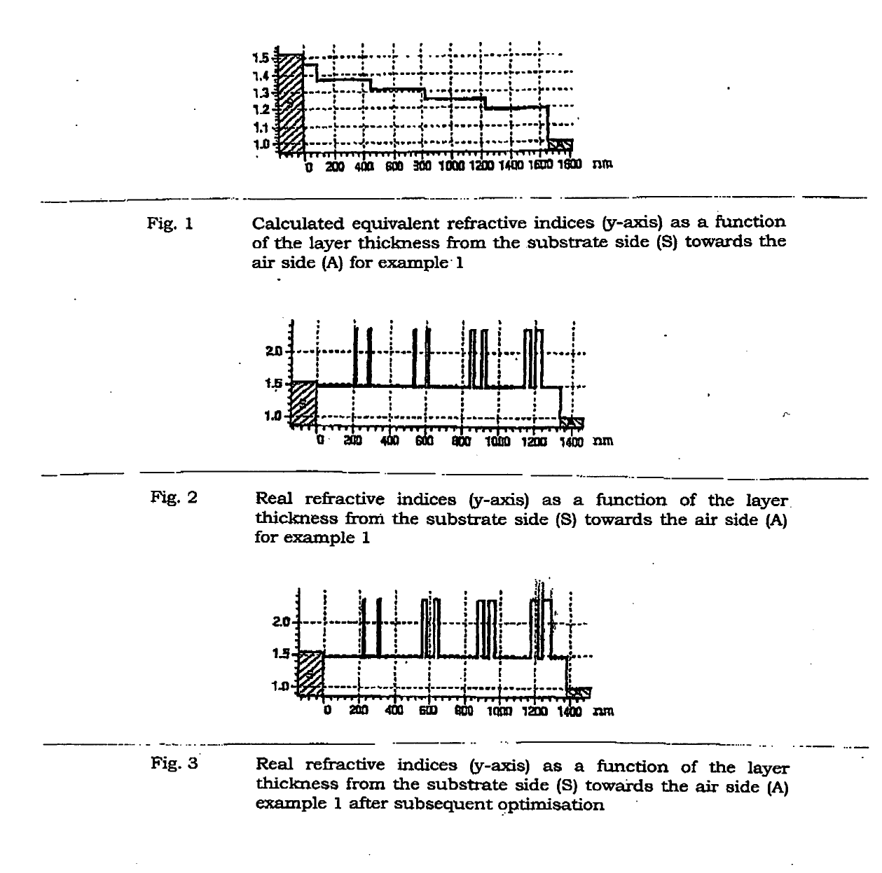

FIG. 1 a diagram with equivalent optical refractive indices of a first example of an optical layer system;

FIG. 2 a diagram of the actual optical refractive indices within the optical layer system;

FIG. 3 optical refractive indices of an optical layer system after computing optimisation is effected;

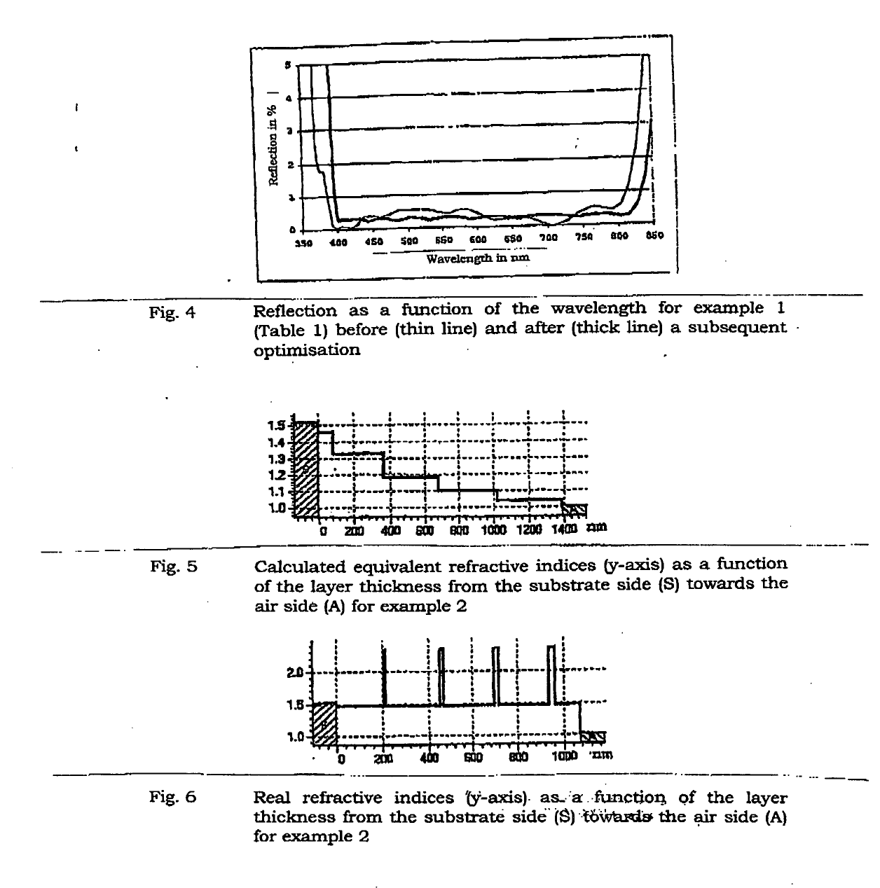

FIG. 4 a diagram with proportions of reflected light within a wavelength interval for an optical layer system according to example 1 and a correspondingly calculated optimised variant thereto;

FIG. 5 a diagram of calculated equivalent optical refractive indices of layer stacks of an optical system for a second example;

FIG. 6 a diagram with actual optical refractive indices for an optical system according to example 2;

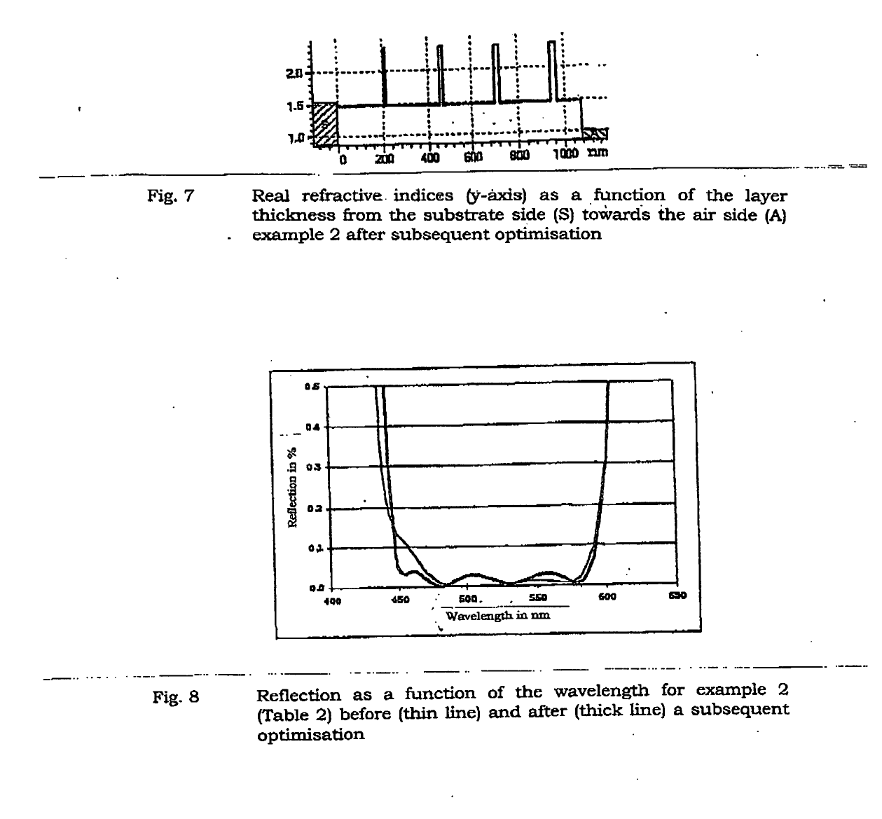

FIG. 7 calculated optical refractive indices for an optimised optical layer system according to example 2;

FIG. 8 a diagram of the proportion of reflected light within a wavelength range of an optical system according to example 2 in an embodied and calculated optimised form and

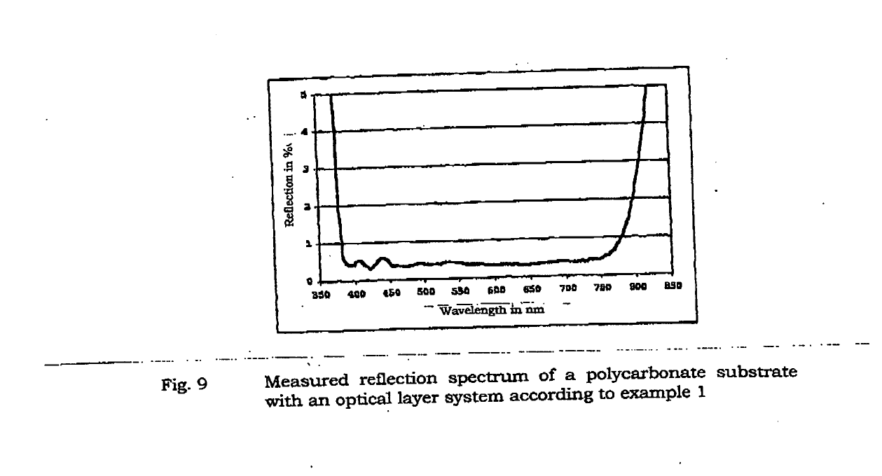

FIG. 9 a diagram from which the proportions of reflected light in the wavelength range of 350 nm to 800 nm can be deduced for a substrate made of polycarbonate with a layer system according to example 1.

### EXAMPLE 1

In example 1, a reduction in reflection of light in the wavelength range between 400 to 800 nm which is ≦0.4% is intended to be achieved.

The optical layer system was formed on a substrate with an optical refractive index of 1.52. Layers L made of SiO₂ were formed with a refractive index n=1.46 and layers H made of TiO₂ with a higher optical refractive index n=2.35.

The design of the optical layer system was effected to the prescribed wavelength λ=500 nm and in total 17 of such individual layers which were disposed changing alternately were formed.

The structure of the layer system can be deduced from the subsequent Table 1a, the respective actual layer thicknesses d (nm), the optical layer thicknesses n×d (nm), the respective ratios c relative to ¼ of the prescribed wavelength λ being indicated for the individual layers L and H.

Furthermore, in total five individual layer stacks A1 to E1 with their respective optical layer thickness (QW thickness) are thereby indicated relative to ¼ of the prescribed wavelength λ and also the respective equivalent optical refractive index of the layer stacks A1 to E1. A1 is thereby a layer, which is disposed directly on the surface of the substrate, comprsing the material with the lower optical refractive index with a layer thickness ¼ of the prescribed wavelength λ.

A layer 1a (A1) which was formed directly on the surface of the substrate and made of SiO₂ as the material with a lower optical refractive index has a thickness which corresponds to ¼ of the prescribed wavelength λ. Thus is favourable since SiO₂ has an optical refractive index of 1.46 which in turn is lower than the optical refractive index of the substrate material.

In Table 1b, the graduated equivalent refractive indices of the layer stacks are intended to be clarified.

TABLE 1a
example 1

| | | | | | | | QW | Equivalent |
|---|---|---|---|---|---|---|---|---|
| Layer | Material | n | D (nm) | n * d (nm) | c | Stack | thickness | refractive index |
| 1a | L | 1.46 | 85.6 | 125.0 | 1.000 | A1 | 1 | 1.46 |
| 1b | L | 1.46 | 121.4 | 177.2 | 1.418 | B1 | 4 | 1.372 |
| 2 | H | 2.35 | 7.9 | 18.6 | 0.148 | | | |
| 3 | L | 1.46 | 70.2 | 102.5 | 0.820 | | | |
| 4 | H | 2.35 | 14.4 | 33.8 | 0.177 | | | |
| 5a | L | 1.46 | 120 | 175.2 | 1.402 | | | |
| 5b | L | 1.46 | 115.7 | 168.9 | 1.351 | C1 | 4 | 1.312 |
| 6 | H | 2.35 | 14.4 | 33.8 | 0.271 | | | |
| 7 | L | 1.46 | 58.6 | 85.6 | 0.684 | | | |
| 8 | H | 2.35 | 16.2 | 38.1 | 0.304 | | | |
| 9a | L | 1.46 | 114.1 | 166.6 | 1.333 | | | |
| 9b | L | 1.46 | 109.2 | 159.4 | 1.275 | D1 | 4 | 1.252 |
| 10 | H | 2.35 | 22.1 | 51.9 | 0.415 | | | |
| 11 | L | 1.46 | 45.4 | 66.3 | 0.529 | | | |
| 12 | H | 2.35 | 24.3 | 57.1 | 0.456 | | | |
| 13a | L | 1.46 | 107.4 | 156.8 | 1.254 | | | |
| 13b | L | 1.46 | 101 | 147.5 | 1.180 | E1 | 4 | 1.192 |
| 14 | H | 2.35 | 32.3 | 75.9 | 0.608 | | | |
| 15 | L | 1.46 | 28.2 | 41.2 | 0.329 | | | |
| 16 | H | 2.35 | 35.8 | 84.1 | 0.673 | | | |
| 17 | L | 1.46 | 98.4 | 143.7 | 1.149 | | | |

TABLE 1b
Graduated refractive index nₛₖ, graduated difference Δnₛ and
stack refractive index n_{E} (equivalent refractive index)
for example 1, k is the stack number.

| k | Stack | nₛₖ | Δnₛₖ | n_{Ek} |
|---|---|---|---|---|
| 0 | — | 1.520 | — | — |
| 1 | A1 | 1.402 | 0.118 | 1.460 |
| 2 | B1 | 1.342 | 0.060 | 1.372 |
| 3 | C1 | 1.282 | 0.060 | 1.312 |
| 4 | D1 | 1.222 | 0.060 | 1.252 |
| 5 | E1 | 1.162 | 0.060 | 1.192 |

In Table 1a, it becomes clear in addition that layers L made of SiO₂ with a lower optical refractive index represent layer thickness proportions in the layer stacks A1 to E1. This relates to layers 1b and 5a, 5b and 9a, 9b and 13a, 13b which are disposed on outer edges of layer stacks B1 to E1.

The outmost layer 17 made of SiO₂ has an optical layer thickness of 143.7 nm which corresponds to 1.14×¼ of the prescribed wavelength λ=500 nm.

The individual layer thicknesses and the layer stacks were determined as follows:

Step 1

A number q is prescribed which determines the number of layer stacks to be used.

Step 2

A residual reflection R₀ is defined which is intended to be achieved at the prescribed wavelength λ. With this value and the refractive index of the surrounding medium n₀, a target refractive index n_{0T} is determined according to

$${n}_{0 T} = \frac{{n}_{0} + \sqrt{{R}_{0}}}{{n}_{0} - \sqrt{{R}_{0}}}$$

Step 3

The difference between the substrate refractive index nₛ and the target refractive index n_{0T} is divided by q and, with this difference, new graduated refractive indices n_{Sk} are formed according to

$$Δ {n}_{S} = \frac{1}{q} ( {n}_{S} - {n}_{0 T} )$$

$${n}_{Sk} = {n}_{Sk - 1} - Δ {n}_{S}$$

with k=1 . . . q as index of the graduations and with nₛₒ=nₛ and n_{sq}=n_{0T}.

Step 4

A layer stack respectively is calculated for each graduation, the optical layer thickness of which should correspond to one to five times ¼ of the prescribed wavelength λ, each layer stack corresponding to an equivalent refractive index which is calculated according to
n_{Ek}=\sqrt{n_{Sk-1}n_{Sk}}
Step 5

If the equivalent refractive index of the first layer stack is approximately equal to the refractive index of the low refractive index material L, the first layer stack with only one λ/4 layer (i.e. a layer, the optical thickness of which is equal to ¼ of a prescribed wavelength λ) of the material is formed with the low optical refractive index.

Step 6

From the refractive index of this layer and the substrate, a new refractive index nₛ₁ of the first substrate graduation is formed according to

$${n}_{S 1} = \frac{{n}_{L}^{2}}{{n}_{S}}$$

Subsequently the procedure is carried out again according to step 3 and 4.

Step 7

It can be advantageous for the configuration of the residual reflection to undertake the linear connection of the graduated equivalent refractive indices according to step 3 instead of in one step in a plurality of steps.

### EXAMPLE 1

Firstly, the first equivalent refractive index of the material with the lower refractive index is determined. Thereafter, all the further graduated equivalent refractive indices are determined according to the linear connection from step 3.

### EXAMPLE 2

Firstly, the first equivalent refractive index is determined again by means of the refractive index of the material with the lower refractive index. Thereafter, only two further graduated equivalent refractive indices are determined and subsequently the remaining two equivalent optical refractive indices.

Step 8

According to the desired bandwidth of the reflection range, optical layer thicknesses for the layer stacks are chosen which correspond to three, four or five times ¼ of the prescribed wavelength λ.

Step 9

In the case of layer stacks which have an optical layer thickness corresponding to three times ¼ of the prescribed wavelength λ which have the desired equivalent refractive index and are formed from three layers, the first and third thereof thereby being an L layer and the middle layer thereof an H layer, the optical layer thicknesses of the layers are calculated according to the formula:

$${c}_{H} = \frac{2}{π} arcsin ( \frac{{n}_{H} / {n}_{L} - {n}_{L} / {n}_{H}}{{n}_{L} / {n}_{H} - {n}_{H} / {n}_{L}} )$$

$${c}_{L} = 1 + \frac{1}{} arccot \{ \frac{1}{2} ( \frac{{n}_{L}}{{n}_{H}} + \frac{{n}_{H}}{{n}_{L}} ) tan {φ}_{H} \}$$

the two L layers being identical and

$${φ}_{H} = \frac{π}{2} \cdot {c}_{H}$$

Step 10

For each equivalent refractive index (of a layer stack with an optical layer thickness which corresponds to three times ¼ of the prescribed wavelength λ), the associated optical thicknesses are determined according to step 9.

Step 11

In the case of layer stacks with an optical layer thickness which corresponds to four times ¼ of the prescribed wavelength λ, the corresponding equivalent refractive index is formed with five layers, the first, third and fifth of which are L layers and the second and fourth layer of which are H layers. The optical layer thicknesses are calculated according to the formulae:

$${c}_{HA} = \frac{2}{π} arcsin ( \frac{{n}_{L} / {n}_{A} - {n}_{A} / {n}_{L}}{{n}_{L} / {n}_{H} - {n}_{H} / {n}_{L}} )$$

$${c}_{HB} = \frac{2}{π} arcsin ( \frac{{n}_{L} / {n}_{B} - {n}_{B} {n}_{L}}{{n}_{L} / {n}_{H} - {n}_{H} / {n}_{L}} )$$

$${c}_{LA} = \frac{2}{π} arccot \{ \frac{1}{2} ( \frac{{n}_{L}}{{n}_{H}} + \frac{{n}_{H}}{{n}_{L}} ) tan {φ}_{HA} \} ; ( {φ}_{HA} = \frac{π}{2} \cdot {c}_{HA} )$$

$${c}_{LB} = \frac{2}{π} arccot \{ \frac{1}{2} ( \frac{{n}_{L}}{{n}_{H}} + \frac{{n}_{H}}{{n}_{L}} ) tan {φ}_{HB} \} ; ( {φ}_{HB} = \frac{}{2} \cdot {c}_{HB} )$$

with the auxiliary refractive indices nA and nB which are calculated according to

$${n}_{ A} = x + \sqrt{ {x}^{ 2} + y} {n}_{ B} = \frac{ {n}_{ A} {n}_{ S}}{ {n}_{ B}}$$

$$with$$

$$x = \frac{{n}_{L} ( {n}_{0} + {n}_{S} ) ( {n}_{L}^{2} - {n}_{B}^{2} )}{2 {n}_{B}^{2} ( {n}_{B} + {n}_{S} )}$$

$$and$$

$$y = \frac{{n}_{L}^{4}}{{n}_{S} {n}_{B}}$$

The optical layer thicknesses of the individual layers are then produced at
C1(L)=1+C_{LA}
C2(H)=C_{HA}
C3(L)=C_{LA}+C_{LB}
C4(H)=C_{HB}
C5(L)=1+C_{LB}
   Step 12

Step 11 is implemented for each equivalent refractive index of the layer stacks, the refractive indices n_{E}, nₛ and no being required to be replaced correspondingly by the current values n_{Ek}, n_{Sk}, n_{Sk-1} or n_{Sk} according to step 3 and 4.

As a result, the absolute total number of layers of such an optical system which are actually to be formed is reduced from 21 to practically 17.

The layer stacks A1 to E1 are respectively formed from five layers comprising respectively SiO₂ as L layers and TiO₂ as H layers which are disposed alternately.

As is shown in FIG. 4, a significant reduction in the reflected proportion of light in the wavelength range between 400 and 800 nm can be achieved with such an optical layer system as defined in example 1. By means of a computational subsequent optimisation (refinement) of this layer system, the reflection behaviour, as shown with the thicker line, was able to be evened out over the described wavelength range and also in addition reduced at least partially since the real optical refractive index dispersions can be taken into account. The layer thicknesses calculated in advance thereby changed only insubstantially (see FIG. 3).

### EXAMPLE 2

With an optical layer system for example 2, the proportion of reflected light in the wavelength range between 450 nm to 570 nm should be lowered to below 0.1%.

Here too, a substrate which had an optical refractive index of 1.52 was provided with an optical layer system according to the invention configured corresponding to this example. Again layers made of SiO₂ and layers H made of TiO₂ which were disposed changing alternately were formed.

The structure of the optical layer system according to this example 2 is produced in the subsequent Table 2a. Table 2b again clarifies the graduations in the equivalent refractive indices which is explained schematically in FIG. 5.

TABLE 2a
example 2

| | | | | | | | QW | Equivalent |
|---|---|---|---|---|---|---|---|---|
| Layer | Material | n | d (nm) | n * d (nm) | c | Stack | thickness | refractive index |
| 1a | L | 1.46 | 85.6 | 125.0 | 1.000 | A2 | 1 | 1.46 |
| 1b | L | 1.46 | 122.8 | 179.3 | 1.435 | B2 | 3 | 1.334 |
| 2 | H | 2.35 | 6.2 | 14.6 | 0.117 | | | |
| 3a | L | 1.48 | 122.8 | 179.3 | 1.435 | | | |
| 3b | L | 1.46 | 116.1 | 169.5 | 1.356 | C2 | 3 | 1.2 |
| 4 | H | 2.35 | 13.8 | 32.4 | 0.261 | | | |
| 5a | L | 1.46 | 116.1 | 169.5 | 1.356 | | | |
| 5b | L | 1.46 | 110.1 | 160.7 | 1.286 | D2 | 3 | 1.1 |
| 6 | H | 2.35 | 21.0 | 49.4 | 0.395 | | | |
| 7a | L | 1.46 | 110.1 | 160.7 | 1.286 | | | |
| 7b | L | 1.46 | 105.2 | 153.6 | 1.229 | E2 | 3 | 1.033 |
| 8 | H | 2.35 | 27.0 | 63.5 | 0.507 | | | |
| 9 | L | 1.46 | 105.2 | 153.6 | 1.229 | | | |

TABLE 2b
Graduated refractive index nₛₖ, graduated difference Δnₛ and
stack refractive index n_{E} (equivalent refractive index)
for example 2, k is the stack number.

| k | Stack | nₛₖ | Δnₛₖ | N_{Ek} |
|---|---|---|---|---|
| 0 | — | 1.520 | — | — |
| 1 | A2 | 1.402 | 0.118 | 1.460 |
| 2 | B2 | 1.269 | 0.133 | 1.334 |
| 3 | C2 | 1.135 | 0.134 | 1.200 |
| 4 | D2 | 1.066 | 0.069 | 1.100 |
| 5 | E2 | 1.001 | 0.065 | 1.033 |

It becomes clear that, in this layer system, again five layer stacks A2 to E2 which are configured one above the other were formed, in each of the layer stacks only one layer H made of TiO₂ being disposed. Such a layer H is again enclosed on both sides by layers L made of SiO₂. Nine layers in total were formed. Layers 1b and 3a, 3b and 5a, 5b and 7a, 7b represent layer thickness proportions of layers L made of a material with a lower optical refractive index.

In the design of this optical layer system according to example 2, the procedure was again begun with a prescribed wavelength λ=500 nm.

The design of the layer thicknesses and layer stacks was determined as in example 1.

The proportions of reflected light in the wavelength range between 450 and 570 nm can be deduced from FIG. 8 for the optical layer system according to example 2 with the thinly drawn line. The thickly drawn line produces the achievable proportion of reflected light taking into account optimisation of the example achieved subsequently by calculation. In the case of such a subsequent optimisation, variable optical properties of the materials forming the respective layers can be taken into account. As mentioned previously, the determined layer thicknesses need thereby be changed only slightly.

Subsequently, a possibility for forming an optical layer system for reducing the reflected proportion of light on an optical window made of transparent polycarbonate is intended to be explained. Such a window can for example be a covering for an electronic display element in automotive vehicles. With such an optical window at an angle of incidence of 60° of light, no red colour effect should occur.

The optical layer system had a total thickness of 1600 nm and layers made of SiO₂ and TiO₂ which were again alternating were deposited by electron beam evaporation. During deposition in a vacuum, the respective layer was bombarded with argon ions which have an energy of 80 eV (SiO₂) and 120 eV (TiO₂) with a current density of approx. 0.1 mA/cm².

A layer structure like the one corresponding to example 1, which has been described already, was chosen. Subsequent optimisation of the respective layer thicknesses was thereby undertaken taking into account the respective real optical refractive index dispersions.

The reflected proportion was able to be kept below 1% in the wavelength range between 380 nm to 770 nm, as can be deduced from the diagram shown in FIG. 9.

The transparency in the wavelength range of visible light was able to be increased to 98% with a two-sided formation of an optical layer system on the optical window as substrate, relative to 92% with a one-sided coating.

In the case of light which is incident at an obliquely inclined angle, a slightly greenish colour effect could be noted. In the case of a vertical light incidence, colour neutrality was achieved.

The optical system formed on the polycarbonate substrate withstood the abrasion test according to ISO 9211-02-04 without forming defects and also an abrasion test with steel wool. The scratch resistance of the polycarbonate substrate was able thus to be increased significantly relative to the uncoated substrate material.

1. An optical layer system for reducing the reflection of optically transparent substrates, having layers of material with a lower optical refractive index and higher optical refractive index disposed layers of material with a alternately on the surface of a substrate, from which layers layer stacks with at least one layer of a material with a higher optical refractive index, which is enclosed by two layers made of a material with a lower optical refractive index, are formed, the layer stacks have an equivalent optical refractive index with respect to a prescribable wavelength λ which is lower than the optical refractive index of the substrate; thereby at least two layer stacks are formed one above the other, the respective equivalent optical refractive index of which is reduced, starting from the substrate and the individual layer stacks have an optical thickness which corresponds at least to twice ¼ of the prescribable wavelength λ.

2. The optical layer system of claim 1 wherein the equivalent optical refractive index of each layer stack is lower than the optical refractive index of a material from which layers with a lower optical refractive index are formed.

3. The optical layer system of claim 1 wherein none of the individual layers of the layer system have an optical layer thickness which corresponds to an integer multiple of ¼ of the prescribable wavelength.

4. The optical layer system of claim 1 including a layer which is formed directly on the surface of the substrate and formed from a material, the optical refractive index of which is lower than the optical refractive index of the substrate, forms a λ/4 layer.

5. The optical layer system claim 1 wherein the optical refractive index of the substrate is ≦2.

6. The optical layer system of claim 1 wherein the layers, the optical refractive index of which is lower, are formed from SiO₂ or MgF₂.

7. The optical layer system of claim 1 wherein the layers, the optical refractive index of which is higher, are formed from at least one of TiO₂, HfO₂, ZrO₂, TA₂O₅, and Nb₂O₅.

8. The optical layer system of claim 1 wherein the individual layer stacks are formed from three, five or seven layers.

9. The optical layer system of claim 1 wherein the uppermost layer, which faces the surrounding medium and is made of the material with a lower optical refractive index, has an optical layer thickness which is greater than ¼ of the prescribed wavelength λ.

10. The optical layer system of claim 1 wherein the layer thickness proportion in the layer stacks of layers which are formed from a material with a higher optical refractive index increases from the substrate surface of the surrounding medium.

11. The optical layer system of claim 1 wherein the layer system has a thickness in the range between 800 and 3000 nm.

12. The optical layer system of claim 1 wherein the prescribed wavelength λ is selected from the wavelength range between 480 and 600 nm.

13. The optical layer system of claim 2 wherein none of the individual layers of the layer system have an optical layer thickness which corresponds to an integer multiple of ¼ of the prescribable wavelength.

14. The optical layer system of claim 2 including a layer which is formed directly on the surface of the substrate and formed from a material, the optical refractive index of which is lower than the optical refractive index of the substrate, forms a λ/4 layer.

15. The optical layer system of claim 3 including a layer which is formed directly on the surface of the substrate and formed from a material, the optical refractive index of which is lower than the optical refractive index of the substrate, forms a λ/4 layer.

16. The optical layer system of claim 13 including a layer which is formed directly on the surface of the substrate and formed from a material, the optical refractive index of which is lower than the optical refractive index of the substrate, forms a λ/4 layer.

17. The optical layer system of claim 2 wherein the optical refractive index of the substrate is ≦2.

18. The optical layer system of claim 3 wherein the optical refractive index of the substrate is ≦2.

19. The optical layer system of claim 13 wherein the optical refractive index of the substrate is ≦2.

20. The optical layer system of claim 4 wherein the optical refractive index of the substrate is ≦2.
